(19) United States
(12) Patent Application Publication
(10) Pub. No.: US 2025/0154369 A1
(43) Pub. Date: May 15, 2025

(54) RESIN COMPOSITION

(71) Applicant: TOYODA GOSEI CO., LTD., Kiyosu-shi (JP)

(72) Inventors: Yukari ITO, Kiyosu-shi (JP); Tsuyoshi SUZUKI, Kiyosu-shi (JP); Hiroaki ANDO, Kiyosu-shi (JP); Koichi MIYAKE, Kiyosu-shi (JP); Takeshi YAGAMI, Kiyosu-shi (JP)

(21) Appl. No.: 18/912,709

(22) Filed: Oct. 11, 2024

(30) Foreign Application Priority Data
Nov. 10, 2023 (JP) 2023-192323

(51) Int. Cl. C09D 7/40; C08K 7/00; C09D 5/24; C09D 7/61

(52) U.S. Cl. CPC C09D 7/70; C09D 5/24; C09D 7/61; C09D 7/69; C08K 7/00; C08K 2201/001; C08K 2201/005

(57) ABSTRACT

A resin composition having electromagnetic wave transparency includes a base resin and filler particles added to the base resin. The filler particles have a higher relative permittivity than the base resin or have conductivity. The filler particles are unevenly distributed in the resin composition.

### CROSS-REFERENCE TO RELATED APPLICATIONS

This application is based upon and claims the benefit of priority from prior Japanese Patent Application No. 2023-192323, filed on Nov. 10, 2023, the entire contents of which are incorporated herein by reference.

### BACKGROUND

### 1. Field

The present disclosure relates to a resin composition.

### 2. Description of Related Art

Japanese Laid-Open Patent Publication No. 2004-244516 discloses a sparkle coating film applied to a painted product that covers an electromagnetic wave radar. The sparkle coating film is formed of a paint composition containing a sparkle material.

The paint composition is a paint containing a resin material as a main component.

With this type of sparkle coating film, it is possible to obtain a painted product that has both sparkling effect and electromagnetic wave transparency.

However, in such sparkle coating films, increasing the content rate of the sparkle material to enhance the aesthetic properties can cause a reduction in electromagnetic wave transparency. This issue is not limited to sparkle coating films. It can also occur in resin compositions in which a filler with a higher relative permittivity than the base resin or a conductive filler is added to the base resin, which is the main component of the paint composition.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a resin composition having electromagnetic wave transparency includes a base resin and filler particles added to the base resin. The filler particles have a higher relative permittivity than the base resin or have conductivity. The filler particles are unevenly distributed in the resin composition.

Other features and aspects will be apparent from the following detailed description, the drawings, and the claims.

### BRIEF DESCRIPTION OF THE DRAWINGS

FIG. 1 is a cross-sectional view showing a vehicle exterior component.

FIG. 2 is an enlarged cross-sectional view of a resin composition according to an embodiment used in a sparkle coating film of the vehicle exterior component shown in FIG. 1.

FIGS. 3A to 3C are schematic diagrams showing states of areas other than filler particles within the sparkle coating film.

FIG. 4 is a graph showing frequency distributions of inter-particle distances in sparkle coating films.

FIG. 5 is an explanatory diagram for a method of analyzing the distribution of inter-particle distances.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

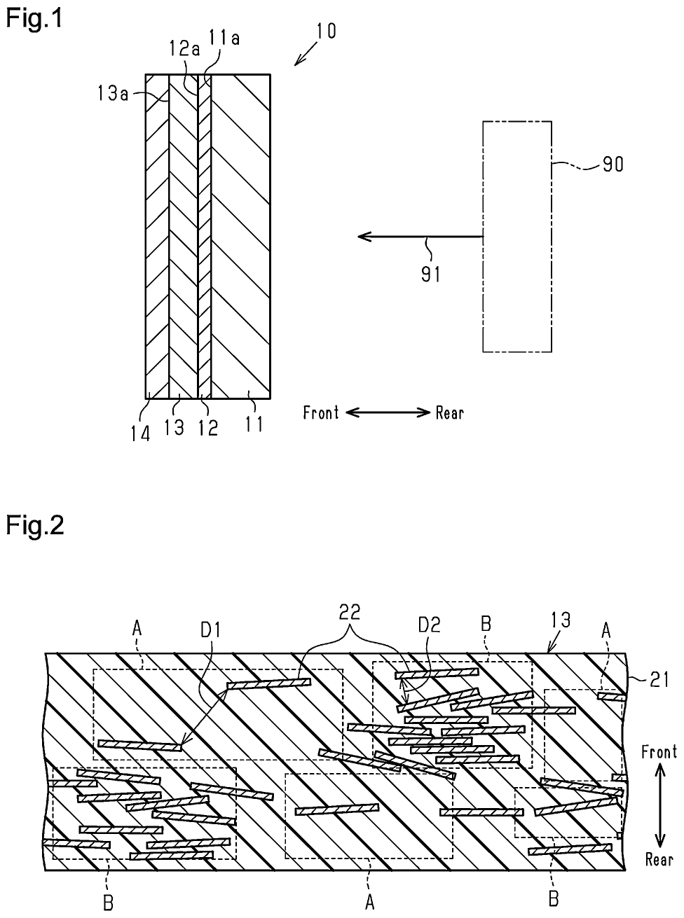

A resin composition according to an embodiment will now be described with reference to FIGS. 1 to 5. In the present embodiment, the present disclosure is embodied as a resin composition used for a vehicle exterior component.

As shown in FIG. 1, a radar device 90 is mounted on a vehicle front part. The radar device 90 emits and receives electromagnetic waves. The radar device 90 emits electromagnetic waves, which are millimeter waves 91 having a wavelength in a range of 1 mm to 10 mm and a frequency in a range of 30 GHz to 300 GHz. In the following description, the ‘front’ and ‘rear’ in the emission direction of the millimeter waves 91 from the radar device 90 will simply be referred to as ‘front’ and ‘rear’, respectively.

### Basic Configuration of Cover 10

The vehicle is provided with a cover 10, which is a vehicle exterior component covering the radar device 90 from the front. The cover 10 has millimeter wave transparency. The cover 10 includes a base 11, a primer layer 12, and a sparkle coating film 13, and a clear coating layer 14.

The base 11 is formed of a synthetic resin material and has millimeter wave transparency. Examples of the resin material, for example, thermoplastic resins such as polypropylene (PP), polyvinyl chloride (PVC), polymethyl methacrylate resin (PMMA), acrylonitrile-butadiene-styrene copolymer (ABS) resin, acrylonitrile-ethylene-propylene-diene-styrene (AES) resin, acrylonitrile-styrene-acrylate copolymer (ASA) resin, and polycarbonate (PC). In the present embodiment, the base 11 is formed of PP.

The primer layer 12 enhances adhesion of the sparkle coating film 13 to the base 11, and is provided on a front surface 11a of the base 11. The primer layer 12 is formed of a known resin paint for a primer.

The sparkle coating film 13 is disposed in front of a front surface 12a of the primer layer 12. The sparkle coating film 13 of the present embodiment corresponds to the resin composition according to the present disclosure.

The clear coating layer 14 imparts durability to the cover 10, for example, and is provided on a front surface 13a of the sparkle coating film 13. The clear coating layer 14 is formed of a known resin paint for clear coating.

### Sparkle Coating Film 13

The configuration of the sparkle coating film 13 will now be described.

As shown in FIG. 2, the sparkle coating film 13 includes a base resin 21 and filler particles 22 added to the base resin 21.

The sparkle coating film 13 is formed by applying a paint containing the base resin 21 and filler particles 22 to the front surface 12a of the primer layer 12. Examples of the application method includes known application methods such as a spray coating method, a dipping method, a shower coating method, a flow coating method, and a roll coating method.

The sparkle coating film 13 has a thickness in a range of 1 μm to 10 mm. The thickness is more preferably in a range of 3 μm to 150 μm. The thickness is further preferably in a range of 5 μm to 100 μm.

The sparkle coating film 13 has millimeter wave transparency. From the perspective of improving the millimeter wave transparency, the two-way millimeter wave transmission attenuation of the sparkle coating film 13 is preferably 5.0 dB or less. More preferably, the two-way millimeter wave transmission attenuation is 3.0 dB or less.

The lightness L* value (hereinafter, L value) in the L*a*b* color space (hereinafter, Lab color space) of the front surface 13a of the sparkle coating film 13 is 40 or greater. From the perspective of improving aesthetic properties, it is more preferable to set the L value to 60 or greater. More preferably, the L value is 80 or greater. As the L value increases, a metallic appearance with high sparkling effect is obtained.

### Base Resin 21

The base resin 21 is a resin material contained in a known resin paint, such as an acrylic resin-based paint, a urethane resin-based paint, a polyester resin-based paint, an epoxy resin-based paint, a melamine resin-based paint, an alkyd resin-based paint, or a phenol resin-based paint. In the present embodiment, the base resin 21 is a urethane-based resin.

### Filler Particles 22

The filler particles 22 may have a relative permittivity higher than that of the base resin 21 or have conductivity. Examples of the filler particles having a relative permittivity higher than that of the base resin 21 include sparkle materials such as mica particles, pearl mica particles, and glass flakes. Examples of the conductive filler particles include metallic conductive filler particles such as aluminum flakes, metal oxide-based conductive filler particles such as zinc oxide flakes, and metal-coated conductive filler particles obtained by coating the surfaces of mica or glass flakes with a metal such as aluminum or nickel.

In the present embodiment, the filler particles 22 are aluminum flakes.

The average particle size of the aluminum flakes is in a range of 3 μm to 30 μm. More preferably, the average particle size of the aluminum flakes is in a range of 4 μm to 25 μm.

The content rate of the aluminum flakes in the sparkle coating film 13 is in a range of 2.0% to 20.0%. From the perspective of improving the aesthetic properties, the content rate is more preferably in a range of 2.5% to 18%.

The area occupancy rate of the aluminum flakes in the sparkle coating film 13 is in a range of 30% to 100%. From the perspective of improving the aesthetic properties, the area occupancy rate is more preferably in a range of 50% to 100%. More preferably, the area occupancy rate is in a range of 70% to 100%.

The sparkle coating film 13 is configured such that the distribution of the inter-particle distance, which is a distance between adjacent ones of the filler particles 22, has a peak.

The inter-particle distance at the peak is in a range of 3.0 μm to 6.0 μm.

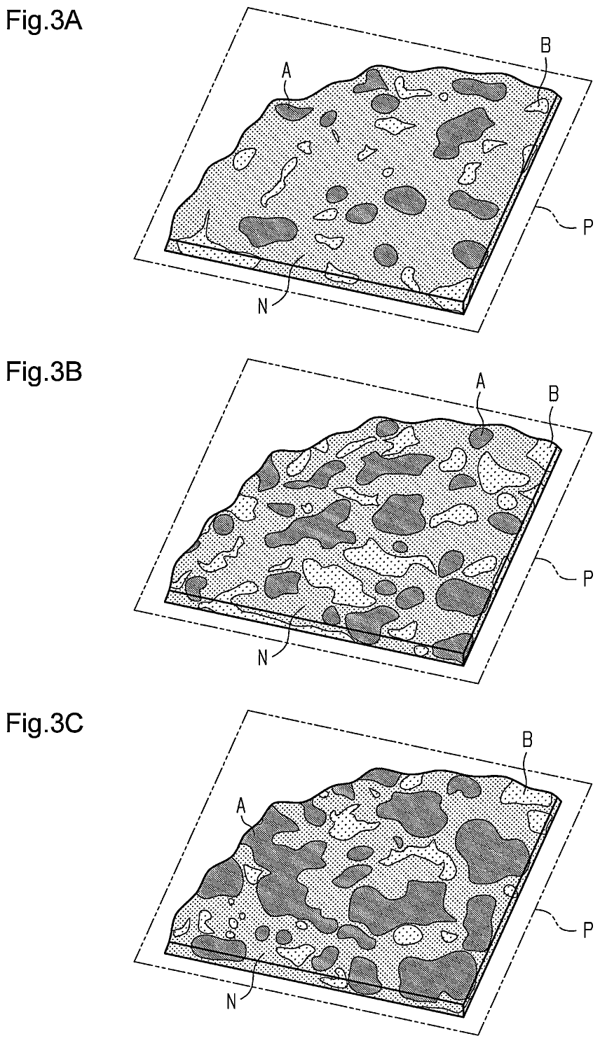

As shown in FIGS. 2 to 3C, the filler particles 22 are unevenly distributed in the sparkle coating film 13. Specifically, regions in which adjacent ones of the filler particles 22 are spaced apart by an inter-particle distance D1 are hereafter referred to as separation regions A. The inter-particle distance D1 is greater than the inter-particle distance at the peak in the sparkle coating film 13. The separation regions A are dispersed throughout the entire sparkle coating film 13 in both a thickness direction (vertical direction in FIG. 2) of the sparkle coating film 13 and a planar direction along an imaginary plane P orthogonal to the thickness direction (see FIGS. 3A to 3C). In the sparkle coating film 13, regions in which adjacent ones of the filler particles 22 are spaced apart by an inter-particle distance D2 are hereinafter, referred to as proximity regions B. The inter-particle distance D2 is less than or equal to the inter-particle distance at the peak. The separation regions A and the proximity regions B are alternately present in both the thickness direction and the planar direction of the sparkle coating film 13. In the present embodiment, the thickness direction agrees with the emission direction of the millimeter waves 91.

### EXAMPLES

Hereinafter, the above-described embodiment will be described more specifically with reference to Examples.

### Preparation of Samples

Paints for forming sparkle coating films of Examples 1 to 3 were prepared as follows. Acrylic urethane resin paint was diluted with a thinner before use. Aluminum flakes were used as the filler particles.

A paint for forming a sparkle coating film of Example 1 was obtained by mixing an acrylic urethane resin paint and aluminum flakes having particle sizes in a range of 5 μm to 25 μm, and sufficiently stirring the mixture.

A paint for forming a sparkle coating film of Example 2 was obtained by mixing an acrylic urethane resin paint and aluminum flakes having particle sizes in a range of 3 μm to 25 μm, and sufficiently stirring the mixture.

A paint for forming a sparkle coating film of Example 3 was obtained by mixing an acrylic urethane resin paint and aluminum flakes having particle sizes in a range of 5 μm to 25 μm, and sufficiently stirring the mixture.

A plate (2.3 mm thick) made of the same material (PP) as the base 11 of the cover 10 was spray-coated with the paint of each Example to form a coating film having a specified thickness (in a range of 1 μm to 10 mm), thereby obtaining a sample.

### Measurement of Samples

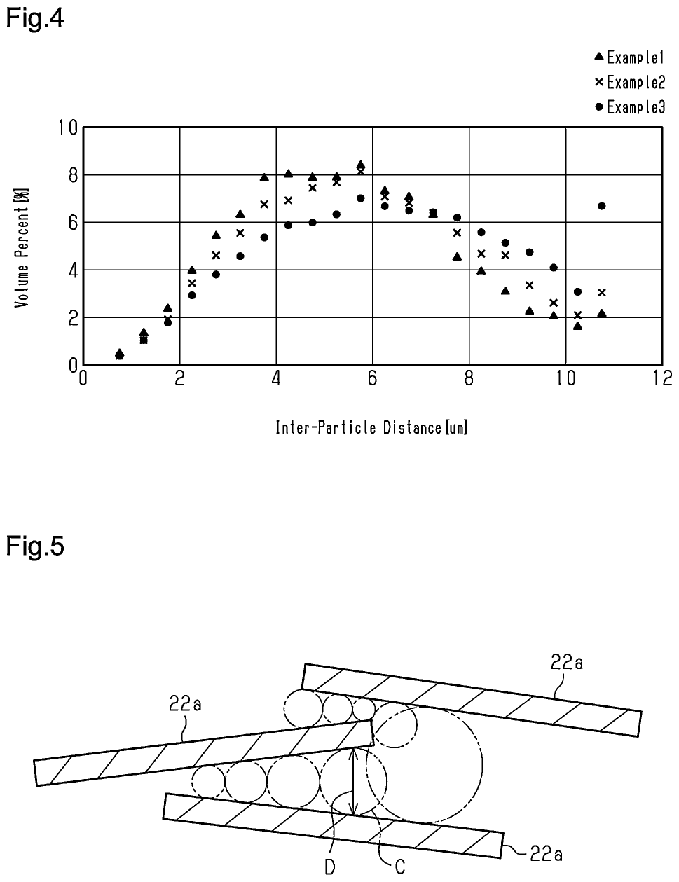

For each of the samples of Example 1 to Example 3, the thickness (film thickness) of the sparkle coating film, the content rate of the aluminum flakes, the area occupancy rate of the aluminum flakes, the relative permittivity, the two-way millimeter wave transmission attenuation, and the L value were measured. In addition, the distribution of inter-particle distances was analyzed. The results are shown in Table 1 and FIGS. 3A to 4.

The content rate of aluminum flakes was measured as follows.

Each sample was photographed with a three-dimensional X-ray microscope. Based on the obtained three-dimensional image, the volume of aluminum flakes present in a range within a distance of 10 μm from the surface of the sparkle coating film in the thickness direction of the sparkle coating film was measured. The ratio of the volume of the aluminum flakes to the volume of the sparkle coating film in that range was calculated as the content rate of the aluminum flakes.

The area occupancy rate of the aluminum flakes was measured as follows.

Each sample was photographed with an optical microscope. Based on the obtained micrographs, the area of the aluminum flakes in a specified range was analyzed with image analysis software. The ratio of the area occupied by the aluminum flakes to the area of the sparkle coating film in that range was calculated as the area occupancy rate of the aluminum flakes.

The two-way millimeter wave transmission attenuation was measured as follows.

Using an electromagnetic wave absorption measuring device, millimeter waves with a frequency of 76.5 GHz were directed to each sample at an incident angle of 0°. After passing through each sample, the same millimeter waves were again directed to the sample at an incident angle of 0°. The transmitted millimeter waves were then received, and the millimeter wave transmission attenuation for each sample was measured. The two-way millimeter wave transmission attenuation of the plate was subtracted from the obtained transmission attenuation to calculate the two-way millimeter wave transmission attenuation of only the sparkle coating film. When the two-way millimeter wave transmission attenuation is 5.0 dB or less, it can be evaluated that the millimeter waves have sufficiently passed through.

The L value was measured as follows.

Using a multi-angle spectrophotometer, the sparkle coating film was irradiated with light at an angle of 25°, and the spectral reflectance at a receiving angle of 25° relative to the specular reflection was measured. Next, the L value in the Lab color space calculated from the spectral reflectance was calculated. When the L value is 40 or greater, the appearance of the sparkle coating film is evaluated as exhibiting sufficient sparkling effect.

Distributions of the inter-particle distances were analyzed as follows using a three-dimensional image obtained by a three-dimensional X-ray microscope.

As shown in FIG. 5, it is assumed that imaginary spheres C exist between adjacent ones of the aluminum flakes 22a within the sparkle coating film. It is further assumed that the largest imaginary spheres C, having a diameter D, fill the gap between the flakes. Based on this assumption, the state of regions within the sparkle coating film other than the aluminum flakes 22a was evaluated for each sample. The maximum diameters D were regarded as the distances between filler flakes (aluminum flakes), and the separation regions A, the proximity regions B, and intermediate regions N were set as follows. The separation region A is a region in which aluminum flakes are adjacent to each other with an inter-particle distance greater than 6.0 μm. The proximity region B is a region in which aluminum flakes are adjacent to each other at an inter-particle distance of 3.0 μm or less. The intermediate region N is a region in which aluminum flakes are adjacent to each other at an inter-particle distance that is greater than 3.0 μm and less than or equal to 6.0 μm. FIGS. 3A to 3C schematically show each of these regions differentiated by shading. FIG. 3A schematically shows Example 1, FIG. 3B schematically shows Example 2, and FIG. 3C schematically shows Example 3. In addition, based on the maximum diameter D of each of the imaginary spheres C filling gaps, a graph of the frequency distribution of the inter-particle distances in the sparkle coating film was created (see FIG. 4).

### Results

TABLE 1

| | | Al | | Millimeter Wave | | |
|---|---|---|---|---|---|---|
| | | Particle | Content | Transparency | | |
| | Thickness | Size | Rate | | Attenuation | Appearance |
| Sample No. | (μm) | (μm) | (%) | Permittivity | (dB) | L Value |
| Example1 | 25.7 | 5~25 | 17.7 | 38.6 | 1.01 | 92.2 |
| Example2 | 22.7 | 3~25 | 15.1 | 35.7 | 0.56 | 91.3 |
| Example3 | 32.7 | 5~25 | 14.7 | 31.0 | 0.24 | 92.2 |

As shown in Table 1, in all of Examples 1 to 3, the thickness was in a range of 1 μm to 10 mm, the content rate of the aluminum flakes was in a range of 2.0% to 20.0%, and the area occupancy rate of the aluminum flakes was 30% or more. Further, the L value at this time was 40 or greater in all cases. These results show that a sparkle coating film exhibiting sufficient sparkling effect was produced in all of Examples 1 to 3. Furthermore, although the aluminum flake content rate varied across the examples, these differences in the aluminum flake content rate had no significant effect on the sparkling effect (L value).

As shown in Table 1, in all of Examples 1 to 3, the two-way millimeter wave transmission attenuation was 5.0 dB or less. This shows that all of Examples 1 to 3 had sufficient millimeter wave transparency.

The two-way millimeter wave transmission attenuation was highest in Example 1 and lowest in Example 3. In general, as the relative permittivity increases, the millimeter wave transparency decreases. Therefore, these results are consistent with the results of the relative permittivity. This shows that Example 2 was superior to Example 1 in millimeter wave transparency. This also shows that Example 3 was superior to Example 2 in millimeter wave transparency.

The above results show that Example 2 improved the millimeter wave transparency, while maintaining the content rate of the aluminum flakes at such a level that the sparkling effect was not changed, as compared with Example 1. The results also show that Example 3 improved the millimeter wave transparency, while maintaining the content rate of the aluminum flakes at such a level that the sparkling effect was not changed, as compared with Example 1 and Example 2.

As shown in FIGS. 3A to 3C, in Examples 1 to 3, the separation regions A and the proximity regions B were dispersed throughout the entire sparkle coating film in both the thickness direction of the sparkle coating film and the planar direction along the imaginary plane P, orthogonal to the thickness direction. In other words, in Examples 1 to 3, the aluminum flakes were unevenly distributed in the sparkle coating films.

With reference to FIGS. 3A to 4, a comparison of Examples 1 to 3 regarding the ratio of the separation region A to the entire sparkle coating film revealed that Example 3 had the highest ratio of the separation region A, while Example 1 had the lowest ratio. This shows that the aluminum flakes were more unevenly distributed in the sparkle coating film in Example 2 than in Example 1. Further, the aluminum flakes were even more unevenly distributed in the sparkle coating film in Example 3 than in Example 1 and Example 2.

The above results show that uneven distribution of the aluminum flakes in the sparkle coating film improved the millimeter wave transparency, while maintaining the aesthetic properties.

The present embodiment has the following advantages.

(1) The filler particles 22 are unevenly distributed in the sparkle coating film 13.

According to such a configuration, the filler particles 22 are unevenly distributed in the sparkle coating film 13, and thus portions are formed in which the distance between adjacent ones of the filler particles 22 is larger than in a case in which the filler particles 22 are uniformly dispersed in the sparkle coating film 13. The millimeter waves 91 thus readily pass through the sparkle coating film 13 via the above-described portions. This reduces the millimeter wave transmission attenuation in the sparkle coating film 13. On the other hand, since the content rate of the filler particles 22 in the sparkle coating film 13 is maintained, the aesthetic properties of the sparkle coating film 13 are less likely to change. The configuration of the embodiment thus improves the millimeter wave transparency while maintaining the aesthetic properties of the sparkle coating film 13.

(2) The sparkle coating film 13 has a thickness in a range of 1 μm to 10 mm. The two-way millimeter wave transmission attenuation of the sparkle coating film 13 is 5.0 dB or less.

The configuration in which the thicknesses of the sparkle coating films 13 are in a range of 1 μm to 10 mm improves the millimeter wave transparency, while maintaining the aesthetic properties of the sparkle coating films 13. The two-way millimeter wave transmission attenuation of the sparkle coating film 13 is therefore 5.0 dB or less. The configuration of the embodiment thus improves the millimeter wave transparency, while maintaining the aesthetic properties of the sparkle coating film 13.

(3) The sparkle coating film 13 is configured such that the distribution of the inter-particle distance, which is a distance between adjacent ones of the filler particles 22, has a peak. The separation regions A are dispersed throughout the entire sparkle coating film 13 in both the thickness direction of the sparkle coating film 13 and the planar direction along the imaginary plane P, orthogonal to the thickness direction.

In this configuration, the separation regions A, in which the filler particles 22 are separated from each other, are three dimensionally dispersed in the sparkle coating film 13. This allows the millimeter waves 91 to readily pass through the sparkle coating film 13 via the separation regions A. The millimeter wave transparency is thus further improved.

(4) The proximity regions B are dispersed throughout the entire the sparkle coating film 13 in both the thickness direction of the sparkle coating film 13 and the planar direction along the imaginary plane P, orthogonal to the thickness direction.

In this configuration, the proximity regions B and the separation regions A are three dimensionally dispersed in the sparkle coating film 13. That is, in the sparkle coating film 13, the proximity regions B and the separation regions A are alternately present in both the thickness direction and the planar direction of the sparkle coating film 13. Therefore, when the sparkle coating film 13 is viewed from the front, the proximity regions B, in which the filler particles 22 are present in proximity to each other, are present in a wide range of the sparkle coating film 13, enhancing the aesthetic properties of the sparkle coating film 13. In addition, since the separation regions A, in which the filler particles 22 are separated from each other, are each present between adjacent ones of the proximity regions B in both the thickness direction and the planar direction, the millimeter waves 91 are readily transmitted through the sparkle coating film 13 via the separation regions A. The configuration of the embodiment thus further improves the millimeter wave transparency, while maintaining the aesthetic properties of the sparkle coating film 13.

(5) The filler particles 22 are metal filler particles having conductivity.

This configuration enhances the sparking effect of the sparkle coating film 13. Therefore, it is possible to achieve an improved millimeter wave transparency of the sparkle coating film 13, while maintaining excellent aesthetic properties.

(6) The filler particles 22 are the aluminum flakes 22a. The average particle size of the aluminum flakes 22a is in a range of 3 μm to 30 μm. The content rate of the aluminum flakes 22a in the sparkle coating film 13 is in a range of 2.0% to 20.0%. The area occupancy rate of the aluminum flakes 22a in the sparkle coating film 13 is in a range of 30% to 100%.

Since the aluminum flakes 22a are used as the filler particles 22, the configuration of the embodiment readily provides the sparkle coating film 13 having a high sparkling effect. The aluminum flakes 22a have a property of poorly transmitting electromagnetic waves such as the millimeter waves 91. In this regard, the above-described configuration enables an even more advantageous effect of improving the millimeter wave transparency while maintaining the aesthetic properties of the sparkle coating film 13. Therefore, it is possible to achieve an improved millimeter wave transparency of the sparkle coating film 13, while maintaining excellent aesthetic properties.

(7) The L value in the Lab color space of the front surface 13a of the sparkle coating film 13 is 40 or greater.

This configuration reliably enhances the sparking effect of the sparkle coating film 13. Therefore, it is possible to achieve an improved millimeter wave transparency of the sparkle coating film 13, while maintaining excellent aesthetic properties.

### Modifications

The above-described embodiment may be modified as follows. The above-described embodiment and the following modifications can be combined as long as the combined modifications remain technically consistent with each other.

The resin composition according to the present disclosure is not limited to the sparkle coating film 13, which has aesthetic properties with excellent sparkling effect. For example, by replacing the filler particles 22 with a known color pigment such as titanium oxide, the resin composition can be embodied as a color coating with superior coloring properties and aesthetic properties. Even in this case, any type of filler particles can be used as long as the relative permittivity of the filler particles is higher than that of the base resin 21.

The resin composition according to the present disclosure is not limited to the sparkle coating film 13, which is applied to the front surface 12a of the primer layer 12, as exemplified in the above-described embodiment. The resin composition may be in the form of a film formed by printing a paint that contains the filler particles 22 on a film base made of a transparent resin material, for example.

This configuration allows the sparkle coating film 13 to be directly adhered to the base 11 in the cover 10. Therefore, the primer layer 12 and the clear coating layer 14 can be omitted.

The resin composition according to the present disclosure may be, for example, a resin molded article obtained by injection-molding a resin material in which the filler particles 22 are dispersed in a resin base material.

As long as the cover 10 is disposed in front of the radar device 90, the position at which the cover 10 is mounted on the vehicle as a vehicle exterior component can be selected as necessary. For example, in a case in which the radar device 90 emits the millimeter waves 91 rearward from the vehicle, the cover 10 may be disposed in front of the radar device 90 in the emission direction of the millimeter waves 91 and rearward of the radar device 90 with reference to the vehicle. The same applies to a case in which the radar device 90 is mounted on the front diagonal or rear diagonal parts of the vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A resin composition having electromagnetic wave transparency, comprising a base resin and filler particles added to the base resin, wherein
the filler particles have a higher relative permittivity than the base resin or have conductivity, and
the filler particles are unevenly distributed in the resin composition.

2. The resin composition according to claim 1, wherein
the resin composition has millimeter wave transparency,
the resin composition has a thickness in a range of 1 μm to 10 mm, and
a two-way millimeter wave transmission attenuation of the resin composition is 5.0 dB or less.

3. The resin composition according to claim 2, wherein
the resin composition is configured such that a distribution of an inter-particle distance, which is a distance between adjacent ones of the filler particles, has a peak,
regions in the resin composition in which adjacent ones of the filler particles are spaced apart by an inter-particle distance greater than the inter-particle distance at the peak are defined as separation regions, and
the separation regions are dispersed throughout the entire resin composition in both a thickness direction of the resin composition and a planar direction along an imaginary plane orthogonal to the thickness direction.

4. The resin composition according to claim 3, wherein
regions in the resin composition in which adjacent ones of the filler particles are spaced apart by an inter-particle distance less than or equal to the inter-particle distance at the peak are defined as proximity regions, and
the proximity regions are dispersed throughout the entire resin composition in both the thickness direction and the planar direction along the imaginary plane, orthogonal to the thickness direction.

5. The resin composition according to claim 1, wherein the filler particles are metal filler particles having conductivity.

6. The resin composition according to claim 5, wherein
the filler particles are aluminum flakes,
an average particle size of the aluminum flake is in a range of 3 μm and 30 μm,
a content rate of the aluminum flakes in the resin composition is in a range of 2.0% to 20.0%, and
an area occupancy rate of the aluminum flakes in the resin composition is in a range of 30% to 100%.

7. The resin composition according to claim 6, wherein an L* value in the L*a*b* color space of a surface of the resin composition is 40 or greater.
